(19) United States
(12) Patent Application Publication
(10) Pub. No.: US 2008/0126233 A1
(43) Pub. Date: May 29, 2008

(54) Purchase notification system

(75) Inventor: Thomas V. Hogan, Stow, MA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Services Organization Inc., Waltham, MA (US)

(21) Appl. No.: 11/605,644

(22) Filed: Nov. 29, 2006

(51) Int. Cl. G06Q 20/00; G06F 15/16

(52) U.S. Cl. 705/35; 709/207

(57) ABSTRACT

A system and a method for transmitting an alert of an account authorization request to a user associated with the account are disclosed. The system generally includes a database operable to receive a notification of an authorization request associated with a financial account of a user, and an alert distributor in communication with the database operable to automatically transmit an alert indicating account activity to the user in at least near-real time. The method generally includes receiving a notification of an authorization request for a financial account of a user, and automatically transmitting an alert to the user in at least near-real time.

### BACKGROUND

Credit cards and other “cashless” purchase arrangements between consumers and financial institutions have become subject to efforts by nefarious types to defraud customers, vendors, and financial institutions in a variety of ways. For example, thieves may steal credit or debit card account numbers or the cards themselves and make purchases before a customer can notify the financial institution that the card has been lost or stolen. Thieves may also perpetrate mail order fraud against vendors with stolen credit or debit card numbers.

Fraud is generally difficult to prevent in such cashless purchase systems, due at least in part to a lapse in time between the actual crime and the appearance of evidence indicating the occurrence of the crime. For example, fraudulent purchases by a thief using a stolen credit card may not be noticed by a customer until they receive an account statement from their lending institution, sometimes over a month after any fraudulent purchase occurs. Websites provided by financial service providers may provide users account access more quickly, but still may not update purchases for hours, or even days, after a purchase. Vendors, especially mail-order and internet vendors, generally have difficulty ensuring that a customer making a purchase is a legitimate cardholder and not a thief. Financial institutions may notice irregularities in spending habits of the customers, but have little else to tip them off that credit card fraud has occurred, at least until a customer notices a fraudulent purchase and reports it to the financial institution. Accordingly, fraudulent purchases have become a cost for customers, vendors, and financial institutions of doing business with credit cards.

Other cashless purchase arrangements, e.g., debit cards, checks, etc., are also subject to the costs of fraud, as they are typically subject to similar delays between the occurrence of fraudulent activity and the appearance of evidence. Therefore cashless purchase mechanisms are more expensive to financial institutions, vendors, and ultimately customers than if fraudulent activity could be prevented more effectively.

### BRIEF DESCRIPTION OF THE DRAWINGS

FIG. 1 illustrates an exemplary architecture of an authorization request notification system; and

FIG. 2 illustrates an exemplary process notifying a user of an authorization request.

### DETAILED DESCRIPTION OF THE PREFERRED EMBODIMENTS

Systems and methods for notifying a user of purchase activity for a financial account are disclosed. The system generally includes a database for receiving an authorization request for a financial account of a user, and an alert distributor in communication with the database which automatically transmits an alert indicating the authorization request to a user generally immediately after the purchase, i.e., in real-time or near real-time. An alert transmitted to a user in near real-time generally arrives immediately after a purchase, less any processing time required for the system to initiate and transmit the alert, and any delay is insignificant. The method generally includes receiving a notification of an authorization request for a financial account of a user, and automatically transmitting an alert to the user in near real-time. The alert may identify the account for which an authorization request was received, a monetary amount associated with the purchase, a vendor where the purchase was made, and/or contact information for a user to notify a financial services organization of possible fraud.

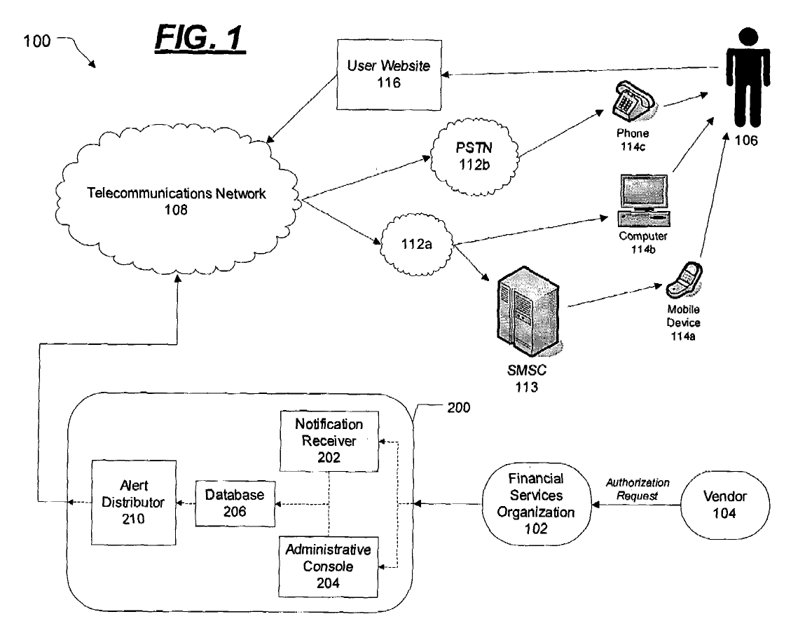

Turning now to FIG. 1, a schematic representation of an exemplary system 100 for alerting a user 106 of activity associated with a financial account of user 106 is illustrated. Financial services organization (FSO) 102 holds a financial account on behalf of user 106, and may generally receive authorization requests from a vendor 104 of goods or services. For example, FSO 102 may be a bank, credit card company, or any other lender or agent of user 106 that provides credit or holds an account in favor of user 106. The account may include a credit card account, a debit card account, any other type of bank account from which user 106 is authorized to draw money or credit, e.g., savings accounts, checking accounts, money market accounts, etc. When a customer, e.g., user 106, makes a purchase, vendor 104 may transmit an authorization request to FSO 102. FSO 102 then automatically transmits an alert to user 106 in real-time or near real-time, thereby notifying user 106 of the purchase activity. Accordingly, user 106 will generally be notified of unauthorized purchases by other users, allowing user 106 to notify FSO 102 in a relatively short period of time after the unauthorized purchase occurs.

System 100 may generally include a notification application 200, telecommunications network 108, at least one linking network 112, and at least one device 114 for receiving alerts. Notification application 200 may include one or more servers, or other hardware and/or software for implementing various functions of notification application 200, as will be described further below. Notification application 200 may be linked with FSO 102 such that FSO 102 may initiate an alert to user 106 after receiving an authorization request from a vendor 104. The alert may generally indicate information such as an account that is charged for the purchase, identity of the vendor, amount of the pending purchase, and/or any additional information regarding the pending purchase that may be convenient.

Virtually any cashless electronic purchase mechanism associated with an account held by user 106 with FSO 102 may be linked with system 100 to provide user 106 with an alert of authorization requests connected with the account. For example, user 106 may hold a credit card account with FSO 102, as is well known. Alternatively, user 106 may hold a savings, checking, or money market account with FSO 102 that is linked to a debit card, as is also well known. Additionally, any account held with FSO 102 may also be linked to Internet purchase devices, e.g., a PayPal account, that allow user 106 to send money electronically to others, typically via an electronic mail (e-mail) message. Any other known cashless purchase mechanism may be employed.

The mechanics of cashless transactions between a customer and vendor 104, e.g., credit cards, debit cards, etc., are generally well known. Typically a customer, e.g., user 106, may make a purchase from vendor 104 with an account held by FSO 102 by providing an account number or other information indicating an account held with FSO 102. The customer may provide an account number in a variety of ways. For example, a customer may provide a card which identifies an account number directly on the card, as is well known. Such cards may also be provided with a magnetic strip to allow vendor 104 to “swipe” the card in equipment which reads account information off of the magnetic strip. Further, the use of a card is not necessary to identify the account. In fact, any other method for identifying the account to vendor 104 may be employed. Upon receiving account information from the customer, vendor 104 transmits an authorization request to FSO 102. For example, vendor 104 may enter account information into equipment provided by FSO 102, which is linked to FSO 102 via telephone, modem, computer network, etc., as is generally known. The authorization request may be sent to FSO 102 through any other method that is convenient. Upon receipt of the authorization request from vendor 104, FSO 102 typically will check that the purchase is authorized, e.g., that the account of user 106 that is associated with the credit card is in good standing, has not exceeded a credit limit assigned by FSO 102, etc. FSO 102 may also make a preliminary determination whether the purchase may be fraudulent, e.g., whether any irregularities indicating fraud are present. FSO 102 may thereafter provide a confirmation to vendor 104 approving the purchase. The confirmation may be transmitted to vendor 104 by any method, and preferably as part of any equipment or communication system used for transmitting the authorization request to FSO 102. Upon receiving an approval from FSO 102, vendor 104 may provide any goods or services which were the subject of the purchase to the customer.

After receiving an authorization request, FSO 102 may initiate an alert to user 106 of account activity with notification application 200. Notification application 200 may transmit an alert to user 106 in a variety of ways. In one exemplary system, FSO 102 may initiate a short message service (SMS) text message to user 106 with notification application 200. Alternatively, notification application 200 may transmit an e-mail to user 106. Any other method of automatically notifying user 106 in real time or near-real time may be employed, such as, for example, an instant message, automated phone message, page, etc. Alerts may be received by user 106 at any device 114, e.g., a mobile device 114a, a computer 114b, or a telephone 114c. User 106 may indicate a device 114 that is preferred for receiving alerts from notification application 200, as further described below. Accordingly, user 106 may be notified of purchases immediately or very shortly after such purchases are made by user 106, or any authorized or unauthorized purchaser. In cases where user 106 receives an alert of an authorization request that user 106 does not recognize, user 106 may contact FSO 102 to indicate possible fraud.

Notification application 200 may be linked with FSO 102 in any variety of ways that may be convenient. Notification application 200 is preferably linked with FSO 102 in such a manner that alerts are processed automatically and immediately, i.e., in real-time or near real-time, when FSO 102 receives an authorization request. Accordingly, notification application 200 may be integrated with existing user and/or billing databases of FSO 102, such that information regarding authorization requests which is typically received by such databases can be immediately shared with notification application 200 for initiating an alert to user 106. Alternatively, notification application 200 may be provided separately from existing databases or mainframes employed by FSO 102 for storing and accessing customer information, billing and purchase records, etc.

Notification application 200 may include or be integrated with any one of a number of known computing devices, including, without limitation, a computer workstation, a desktop, notebook, laptop, or handheld computer, or some other known computing device. Computing devices such as the foregoing may employ any of a number of known computer operating systems, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system.

Computing devices in various embodiments such as notification application 200 may each include instructions executable by one or more computing devices such as those listed above. Such instructions may be compiled or interpreted from computer programs created using a variety of known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

One embodiment of notification application 200 includes notification receiver 202, administrative console 204, database 206, and alert distributor 210. Notification receiver 202 is operable to receive data from FSO 102 related to authorization requests received by FSO 102 such as information identifying a user 106, accounts associated with user 106, a vendor 104, and contact information for FSO 102. Notification receiver 202 may include any software or hardware for receiving such data and/or compiling such data from existing databases (not shown) of FSO 102. Notification receiver 202 may be configured to receive data for a large number of such authorization requests at any one time, such that FSO 102 may initiate authorization request alerts to a large number of users 106 simultaneously. Notification receiver 202 may collect such data from FSO 102 in any format that may be convenient.

Notification application 200 additionally includes an administrative console 204. Administrative console 204 provides an access point for an operator or administrator of FSO 102 to access database 206, described below, and other data or subsystems contained within notification application 200. For example, FSO 102 may add, delete, or update records related to a plurality of users 106 stored within database 206, including information related to accounts held by FSO 102, and any other related data that may be convenient to store in database 206. Administrative console 204 may also provide a connection between a mainframe or other existing computer or database systems of FSO 102, such that FSO 102 may allow notification application 200 access to information regarding users 106 which is stored within such existing database systems.

Database 206 may generally include a memory which stores information related to alerts of authorization requests associated with accounts held by user 106. Notification application 200 may generally use such information when notification receiver 202 receives a notification of an authorization request from FSO 102. For example, database 206 may store a listing of all users 106 associated with accounts of FSO 102, and information related to accounts held by each user 106 with FSO 102, and notifications of authorization requests which are transmitted to users 106. Database 206 may further store preferences for each user 106 related to notifications transmitted to each user 106. For example, user 106 may set dollar amount thresholds to limit which purchases by a customer will generate a notification, e.g., a notification will be sent to user 106 only when the purchase amount is greater than fifty dollars. Database 206 may also store overrides associated with preferences that may be established by user 106 or by an administrator of database 206. For example, where a specified number or dollar amount of all transactions associated with a financial account is exceeded in a predetermined period of time, e.g., 24 hours, notification application 200 may transmit an alert of an authorization request to user 106 despite a transaction dollar amount associated with the authorization request being below a threshold indicated by user 106. Additionally, user 106 may enter information regarding a preferred device 114 where alerts may be transmitted, e.g., a mobile telephone number, e-mail address, computer internet protocol (IP) address, land-line telephone number, etc. Database 206 may also store other information convenient for administration or operation of notification application 200. For example, database 206 may store information useful for an administrator, e.g., FSO 102, of notification application 200. For example, a log of transaction activity for each user 106, or billing information for each user 106 may be stored within database 206.

Database 206 may include a structured file (e.g., comma delimited, tab delimited, etc.) or a relational database management system (RDBMS) as is well known. An RDBMS generally employs the well known Structured Query Language (SQL) in addition to a language for creating, storing, editing, and executing stored procedures. However, it is to be understood that database 206 may be any other kind of database, e.g., a hierarchical database, a file, a set of files, an application database in a proprietary format, etc. Database 206 generally includes a computing device employing a computer operating system such as one of those mentioned above, and is accessible via a networking technology as is well known, such as a local area network (LAN), wide area network (WAN), etc.

Alert distributor 210 is in communication with database 206, and is generally operable to transmit alerts in a variety of formats to a device 114 associated with user 106. Alert distributor 210 generally includes hardware and/or software for creating and transmitting alerts in various formats, e.g., SMS text messages, e-mails, instant messages, automated phone messages, etc., via telecommunications network 108. As an example, alert distributor 210 may transmit an SMS text message to a mobile device 114a of user 106. In other embodiments, alert distributor 210 may transmit other types of alerts to various other devices 114, e.g., an e-mail message or an instant message to mobile device 114a or computer 114b, an automated phone message or page to a mobile device 114a or phone 114c, etc. Alert distributor 210 may receive a signal from database 206 indicating that an authorization request has been received, and that an alert should be transmitted to user 106. Database 206 preferably provides information to be included in the notification to user 106, such as information identifying an account held by user 106 with FSO 102 that has been used in a purchase, an identity of vendor 104, a dollar amount of the purchase, and/or contact information for user 106 to notify FSO 102 if fraud is suspected. Alert distributor 210 may format the alert into a desired format for device 114 and address the alert to user 106, as may be indicated by information residing on database 206. For example, a user 106 may indicate a particular mobile device 114a, a computer 114b, or telephone 114c to which alerts for user 106 should be sent, as further described below.

System 100 may further include telecommunications network 108 in communication with notification application 200. The structure and general operation of such networks is well known. Accordingly, it is to be understood that network 108 may include hardware and/or software, e.g., switches, links, routers, gateways, etc. as necessary to facilitate the transmission of data to a plurality of devices 114. Notification application 200 may be linked with network 108 via any variety of known methods or equipment. Accordingly, notification application 200 is operable to transmit alerts to mobile device 114 via network 108.

System 100 may employ one or more linking networks 112 for transmitting alerts to various devices 114, which are generally well known. For example, system 100 may include an IP network 112a for transmitting alerts to computer-based devices 114, e.g., mobile device 114a, computer 114b, etc. Alternatively, or in addition to IP network 112a, system 100 may include a Public Switched Telephone Network (PSTN) 112b for transmitting alerts to telephone 114c. Many other examples of appropriate linking networks 112 for various devices 114 are well known.

In one embodiment, system 100 may further include a Short Message Service Center (SMSC) 113 for transmitting SMS text message alerts. SMSC 113 generally provides store-and-forward functionality for an alert initiated by notification application 200 in the form of a SMS text message. SMSC 113 may generally include one or more specialized computers to transmit SMS text messages to a plurality of mobile devices 114. SMSC 113 may be in communication with at least one telecommunications tower (not shown) for transmitting SMS text messages to mobile device 114a, as is well known. Each SMSC 113 is generally associated with one or more towers and each generally simultaneously or nearly simultaneously handles SMS text messaging for a plurality of mobile devices 114, including at least monitoring all SMS text communications, tracking the location of each mobile device 114, e.g., phone. One or more telecommunications towers may also provide other communication functionality for mobile device 114a, such as transmitting telephone calls to and from mobile device 114a, as is known.

Although a specific exemplary system 100 is depicted in FIG. 1, a system implemented according to the present invention may include additional components or the components described above interconnected in various other configurations. For example, any or all of notification application 200, notification receiver 202, administrative console 204, database 206, or alert distributor 210 may be directly connected to or integrated with telecommunications network 108 or linking networks 112. In addition, SMSC 113 may be replaced or incorporated within other switching platforms, for example, with known circuit switching equipment or known packet-switching/routing equipment—which may serve mobile device 114.

It is to be understood that there may be a large number of telecommunications devices in communication with or through system 100 at any given time, to facilitate transmitting alerts to a large number of users 106. For example, a large number of SMSCs 113 may be provided to handle transmitting alerts in the form of SMS text messages to a large number of users 106 at a given time. Additionally, system 100 likely will include hundreds if not thousands of telecommunications towers and other associated equipment for transmitting alerts. Moreover, FIG. 1 should not be interpreted to suggest that there is necessarily any geographic limitation to system 100. In fact, system 100 may facilitate alerts across different cities, states, and even countries.

System 100 additionally includes one or more devices 114 operable to receive alerts for a user 106. Various devices 114 may be employed to support alerts in formats associated with each type of device 114. For example, a mobile device 114a may be a wireless telephone, although other kinds of telecommunications devices may be included in various embodiments of mobile device 114a. For example, mobile device 114a could include a variety of devices used to place and receive voice telephony calls and transmit or receive data communications such as e-mail messages, SMS text messages, instant messages, or automated phone messages, such as handheld computers, personal digital assistants, wireless e-mail devices, or devices that include some combination of a computer and a telephone. Mobile device 114a may advantageously have a size and weight enabling user 106 to carry mobile device 114a in a pocket or briefcase, such that alerts transmitted via mobile device 114a may be received quickly by user 106 anywhere within a service area associated with mobile device 114a.

Other devices may be used in place of or in addition to mobile device 114a. For example, computer 114b may be utilized to receive alerts in the form of instant messages, e-mails, or any other message format supported by computer 114b. Additionally, phone 114c may be employed to receive alerts in the form of automated phone messages, pages, voice mail, etc.

User website 116 may be provided as an access point for user 106 to enter and store information related to accounts held by user 106 with FSO 102. User website 116 may be in communication with notification application 200 via network 108, or any other way convenient for enabling user 106 to access database 206. For example, user 106 may define various preferences and/or overrides for receiving alerts, and store such preferences and/or overrides in database 206. Preferences may include dollar amount thresholds for transmitting alerts, contact information for user 106, e.g., addressing information for device 114, or any other customizable aspect of system 100 that may be desirable. Addressing information for device 114 may include any information typically associated with various devices 114 used to transmit communications to a particular device 114, e.g., a telephone number, e-mail address, instant messaging address, etc. User website 116 preferably allows user 106 to define a plurality of devices 114 to which alerts may be sent in various corresponding formats. Accordingly, user 106 may select a particular device where it is convenient for user 106 to receive alerts for a given time period. For example, user 106 may select mobile device 114a when traveling, such that user 106 may receive alerts when user 106 is unable to access a computer 114b or telephone 114c. Alternatively, user 106 may select a computer 114b or telephone 114c for receiving alerts for a defined period of time, such as when user 106 does not have access to a mobile device 114a, or is beyond a service area of mobile device 114a. User preference information may be stored within notification application 200, e.g., within database 206, such that notification application 200 may retrieve preference information when transmitting an alert to user 106. User 106 may access user website 116 over the Internet such that user 106 may add, delete, or update preference information from any computer connected to the Internet.

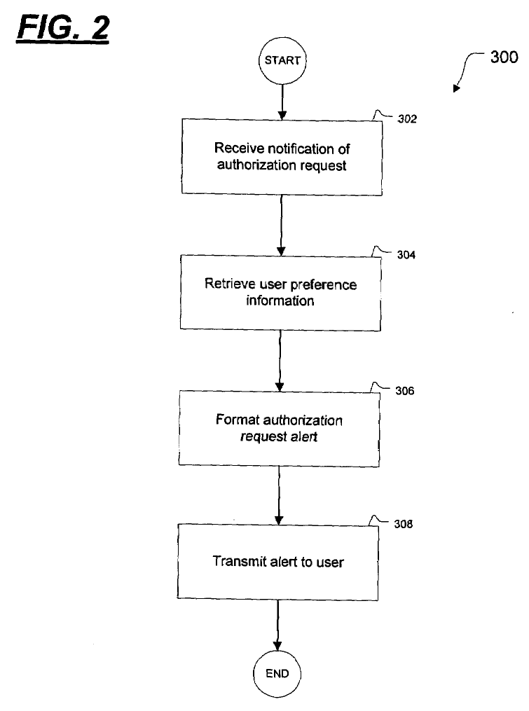

Turning now to FIG. 2, an exemplary process 300 for providing an alert of a authorization request to a user 106 is shown. Process 300 begins at step 302, where notification application 200 may receive a notification from FSO 102 that an authorization request has been received from vendor 104, as described above. Process 300 may then proceed to step 304.

In step 304, notification application 200 may retrieve user preference information, e.g. user preferences stored in database 206, as described above. Process 300 may then proceed to step 306.

In step 306, notification application 200 formats an alert to be transmitted to user 106. Alert distributor 210 may format an alert for transmitting an SMS text message, an e-mail, instant message, telephone message, or any other message which may be transmitted to user 106 in near real-time. Such formatting may include providing addressing information for the alert, e.g., addressing an SMS text message to mobile device 114a. Messaging distributor 210 may recall preference information stored within database 206 to determine how alerts should be formatted, e.g., as a SMS text message, and transmitted to user 106, e.g., to mobile device 114a. Process 300 then proceeds to step 308.

In step 308, notification application 200 transmits an alert to user 106 which indicates the authorization request received by FSO 102. The alert may be transmitted to user 106 in a variety of formats, as described above. For example, alert distributor 210 may transmit an SMS text message alert via telecommunications network 108. Alternatively, alert distributor may transmit e-mail messages, instant messages, automated phone messages, or any other form of communication otherwise convenient for transmitting an alert to user 106 in near real-time.

Reference in the specification to “one embodiment” or “an embodiment” means that a particular feature, structure, or characteristic described in connection with the embodiment is included in at least one embodiment. The phrase “in one embodiment” in various places in the specification does not necessarily refer to the same embodiment each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A method, comprising:
receiving a notification of an authorization request for a financial account associated with a user; and
transmitting to the user, in at least near real-time upon receiving the notification, an alert identifying at least the financial account.

2. The method of claim 1, the alert including at least one of a short message service message, an electronic mail message, and an instant message.

3. The method of claim 1, the alert including an automated phone message.

4. The method of claim 1, further comprising receiving at least one alert preference from the user.

5. The method of claim 4, the user submitting the alert preference through an Internet website.

6. The method of claim 4, establishing the alert preference in the form of a monetary threshold for transmitting the alert.

7. The method of claim 6, further comprising overriding the monetary threshold for transmitting the alert when one of a number of transactions associated with the financial account and a transaction dollar amount associated with the financial account exceeds a predetermined amount within a predetermined period of time.

8. The method of claim 4, establishing the alert preference in the form of an identification of a device associated with the user, wherein transmitting the alert to the user includes transmitting the alert to the device.

9. The method of claim 1, the alert identifying at least one of contact information associated with a service provider of the account, a monetary amount associated with the account authorization request, and a vendor associated with the account authorization request.

10. The method of claim 1, the account being one of a credit card account, a debit card account, and a bank account.

11. A system, comprising:
a database operable to receive a notification of an authorization request associated with a financial account of a user; and
an alert distributor in communication with the database, the alert distributor operable to automatically transmit an alert upon notification to the user, the alert indicating at least the financial account associated with the notification.

12. The system of claim 11, wherein the alert is transmitted to the user in at least near real-time upon receiving the notification.

13. The system of claim 11, wherein the alert is one of a short message service text message, an electronic mail message, and an instant message.

14. The system of claim 11, wherein the alert is an automated phone message.

15. The system of claim 11, further comprising a telecommunications network in communication with the alert distributor, wherein the alert is transmitted to the user via the telecommunications network.

16. The system of claim 15, further comprising a short message service center in communication with the telecommunications network, the alert including a short message service text message.

17. The system of claim 11, further comprising an administrative console in communication with the database, the administrative console linking a computer system associated with a service provider of the financial account with the database.

18. The system of claim 11, wherein the database is operable to receive at least one alert preference from the user.

19. The system of claim 18, wherein the at least one preference includes a monetary threshold for transmitting the alert.

20. The system of claim 19, wherein the monetary threshold for transmitting the alert may be overridden when one of a number of transactions associated with the financial account and a transaction dollar amount associated with the financial account exceeds a predetermined limit within a predetermined period of time.

21. The system of claim 18, wherein the at least one preference includes addressing information for a device operable to receive the alert.

22. The system of claim 18, wherein the alert preference is submitted by the user through a website in communication with the database.

23. The system of claim 11, the alert including at least one of contact information associated with a service provider of the account, a monetary amount associated with the account authorization request, and a vendor associated with the account authorization request.

24. The system of claim 11, the account being one of a credit card account and a bank account.
